(19) United States
(12) Patent Application Publication
(10) Pub. No.: US 2008/0019293 A1
(43) Pub. Date: Jan. 24, 2008

(54) Apparatus and Method for Assigning Resource in a Mobile Communication System

(76) Inventors: Yong Chang, Gundang-gu (KR); Jun-Hwan Oh, Gyeonggi-do (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/571,680

(22) PCT Filed: Jul. 12, 2004
(86) PCT No.: PCT/KR04/01721

§ 371 Date: Feb. 26, 2007

(30) Foreign Application Priority Data
Jul. 12, 2003 (KR) 10-2003-0047524

(51) Int. Cl. H04B 7/00

(52) U.S. Cl. 370/310

(57) ABSTRACT

Disclosed is an apparatus and method for assigning resource in a mobile communication system. In an IP-based next generation mobile communication system, vocoder voice data between a media gateway and a base station controller is not concentrated into a particular vocoder resource but uniformly assigned to all vocoder resources, thereby contributing to efficient assignment of resources in the media gateway.

### FIELD OF THE INVENTION

The present invention relates generally to a resource assignment apparatus and method in a mobile communication system supporting, and in particular, to an apparatus and method for assigning resource in a mobile communication system provided for transmitting voice information.

### DESCRIPTION OF THE RELATED ART

As the number of mobile communication subscribers rapidly increases and mobile communication services are provided in association with Internet services, a study is being conducted on technology for enabling the subscribers to receive various types of data services such as Internet services and multimedia services through mobile communication terminals. A mobile communication system for providing such data services uses employs Multiple Access. Typically, Multiple Access is classified into Time division Multiple Access (TDMA), Code Division Multiple Access (CDMA), and Frequency division Multiple Access (FDMA). A CDMA 2000 1x system supporting CDMA among the technologies. will be described herein below with reference to the accompanying drawing.

The CDMA 2000 1x system, as illustrated in FIG. 1, is divided into a plurality of base stations (BSs) 20, a mobile switching center (MSC) 30 for switching voice data and packet data transmitted/received by a mobile station 10 to a corresponding destination in association with the base stations 20, and a packet data service node (PDSN) 40 for interfacing with an external network. In addition, the CDMA 2000 1x system includes an interwoiking function (IWF) 50 for converting circuit data into packet data before concatenation upon receipt of a data transmission request from the mobile switching center 30, and a packet control function (PCF) 60 for interfacing voice data and packet data between the packet data service node 40 and the base station 20.

The base station 20 is comprised of base transceiver stations (BTSs) 22 and 23, and a base station controller (BSC) 21 for controlling the base transceiver stations 22 and 23.

Signal between the mobile switching center 30 and the base station controller 21 are defined in an A1 interface, and user information therebetween is defined in A2/A5 interfaces (or circuit data-only interfaces). An A3 interface (not shown) is defined to simultaneously transmit/receive control signals and user data during reverse frame selection and forward frame forwarding between a current base station controller and another base station controller when soft handoff occurs to the mobile station 10.

The base station controller 21 includes a transcoder (Xcoder) 24. The transcoder 24 (hereinafter referred to as a “vocoder”), when the base station controller 21 receives a radio vocoder frame transmitted from the mobile station 10, such as Enhanced Variable-Rate Codec (EVRC) frame, Selectable Mode Vocoder (SMV) frame and Qualcomm-Code Excited Linear Prediction Coding (Q-CELP) frame, converts the received radio vocoder frame into a Pulse Code Modulation (PCM) vocoder frame in order to forward the vocoder frame to a wired concentrating network.

Generally, voice signals transmitted on a wired line are transmitted at a rate of 64 Kbps on a TDM transmission line. Therefore, the TDM-based transmission line is also used for transmission of voice signals between the base transceiver stations 22 and 23 and the base station controller 21, and between the base station controller 21 and the mobile switching center 30. Because voice signals are transmitted on a wired line, a specific TDM logical channel must be assigned for transmission of the voice signals. If a fixed channel is set up for only one user in a TDM logical channel transmitted on a wired line, voice signals of other users cannot be transmitted through the channel. In addition, a channel for transmitting the voice signals, after it is assigned to a user who cannot transmit other packet data, becomes a fixed channel. Therefore, until communication of a corresponding user ends, a specific channel on a wired line must be assigned for only one user undesirably.

### SUMMARY OF THE INVENTION

It is, therefore, an object of the present invention to provide a method for efficiently assigning vocoder resource for data transmission between a base station controller and a media gateway in a packet-based mobile communication system.

To achieve the above and other objects, there is provided a method for transmitting/receiving packet data using a base station in a mobile communication system for transmitting/receiving the packet data including a voice call. The method comprises receiving a call attempt message from a mobile station; transmitting a service request message including a frame offset for call processing; receiving a frame offset included in a reply message for the service request message; and setting up a radio channel to the mobile station based on the received frame offset.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a general mobile communication system;

FIG. 2 is a block diagram illustrating a method for assigning resource in a mobile communication system according to an embodiment of the present invention;

FIG. 3 is a scenario illustrating a vocoder resource assignment method during call origination in a mobile communication system according to an embodiment of the present invention;

FIG. 4 is a scenario illustrating a vocoder resource assignment method during hard handoff in a mobile communication system according to an embodiment of the present invention; and

FIG. 5 is a flowchart illustrating a method for assigning resource in a media gateway according to an embodiment of the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

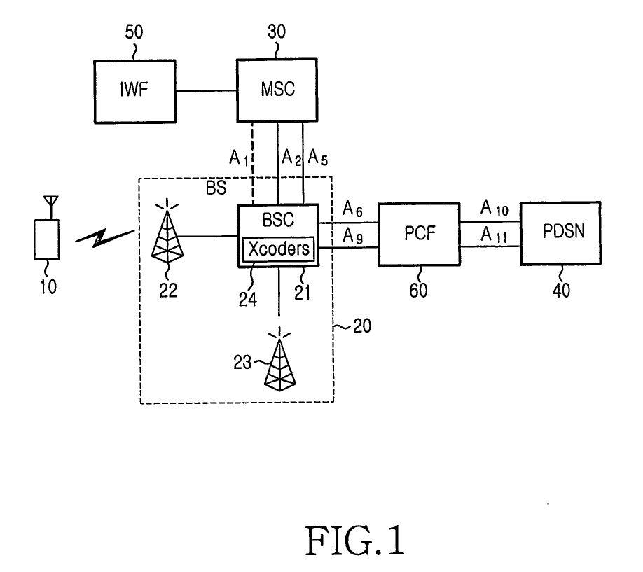

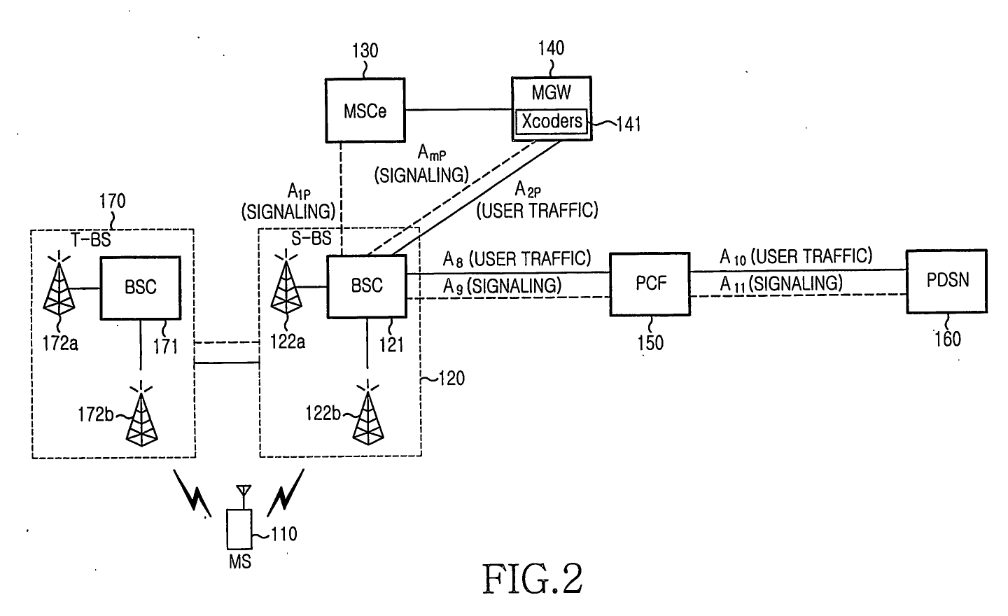

A next generation mobile communication system according to an embodiment of the present invention, as illustrated in FIG. 2, is divided into an MSC emulator (MSCe) 130 for managing call control and mobility control for an existing mobile switching center 30, and a media gateway (MGW) 140 for transcoding and forwarding voice data. Here, the media gateway 140 includes a transcoder 141 therein, and a base station controller 121 includes no transcoder. Accordingly, an existing bearer interface for transmitting voice information between the mobile switching center 30 and the base station controller 21 illustrated in FIG. 1 corresponds to an interface between the media gateway 140 and the base station controller 121 in a mobile communication system according to an embodiment of the present mvention. Therefore, voice data between the base station controller 121 and the media gateway 140 is not transmitted with a 64-Kbps PCM frame described in the conventional technology, but is transmitted with a data frame generated by a radio vocoder. In addition, in order to forward voice information to be transmitted and received to/from a mobile station 110, a frame protocol capable of determining a transmission state between the media gateway 140 and the base station controller 121 and an arrival order of packets is newly set up. The newly setup frame protocol will be described herein below using Table 1 to Table 7.

The next generation mobile communication system illustrated in FIG. 2 according to an embodiment of the present invention, which is a CDMA 2000 1x Legacy MS Domain (LMSD) system, is illustrated through a network reference model between a Radio Access Network (RAN) and a Core Network (CN). A structure of the next generation mobile communication system (hereinafter referred to as a “CDMA 2000 1x”) will be described herein below with reference to the accompanying drawing.

The CDMA 2000 1x LMSD system, as illustrated in FIG. 2, is comprised of a base station controller 121, an MSC emulator (MSCe) 130, a media gateway 140, a packet control function (PCF) 150, and a packet data service node (PDSN) 160. The existing MSC 30 is divided into the MSC emulator 130 and the media gateway 140. The base station controller 121 can also be described as a base station.

The media gateway 140 interworking with the base station controller 121, includes a transcoder (or a vocoder) 141 for managing conversion between an analog voice signal into a digital signal. The transcoder 141 converts a voce data frame transmitted from a wired telephone into a radio vocoder frame used by a mobile station using PCM. In addition, the transcoder 141 converts voice data generated by a radio vocoder of the mobile station 110 into 64-Kbps PCM voice data.

The MSC emulator 130 manages call control and mobility control, and controls the media gateway 140.

The packet control function 150 interworking with the packet data service node 160 connected to the external network, performs handoff control and management, and manages a packet data service profile of a mobile station.

A signal corresponding to a general A1 interface is an ‘A1p’ interface between the MSC emulator 130 and the base station controller 121, and a signal corresponding to an A2 interface is an ‘A2p’ interface between the base station controller 121 and the media gateway 140. Further, an out-of-band signaling process for bearer setup and management is performed through an ‘Amp’ interface between the base station controller 121 and the media gateway 140. Here, functions defined in the ‘Amp’ interface can also be performed in an A2p frame protocol through an in-of-band signaling process. The ‘A1p’, ‘A2p’ and ‘Amp’ interfaces are not based on circuit, but based on packet (ATM or IP).

An example of a protocol stack defined in the interfaces between the base station controller 121 and the media gateway 140 and between the base station controller 121 and the MSC emulator 130 will be described herein below with reference to Table 1. The protocol stack described in connection with Table 1 includes a part newly added according to an embodiment of the present invention and a part needed to be changed in a general protocol stack in addition to the protocol stack defined in the current standard.

TABLE 1

| IOS | IOS | | | | |
|---|---|---|---|---|---|
| A1p | A1p | EVRC/SMV | EVRC/SMV | IOS Amp | IOS Amp |
| SUA | SCCP | FP | FP | | |
| SCTP | M3UA | RTP | GRE | | |
| | SCTP | UDP | | SCTP | TCP/UDP |
| IP | IP | IP | IP | IP | IP |
| L2 | L2 | L2 | L2 | L2 | L2 |
| L1 | L1 | L1 | L1 | L1 | L1 |
| Case 1 | Case 2 | Case 1 | Case 2 | Case 1 | Case 2 |

| | | |
|---|---|---|
| A1p interface | A2p interface | Amp interface |

Case 1 applied in the present invention through the above protocol stack will be described herein below, and a description of Case 2 will be omitted.

Real time Transport Protocol (RTP) and Generic Route Encapsulation (GRE) used in an A2p protocol stack are slightly modified from general RT? and GRE in their functions, and it means that a function for multiplexing a plurality of users with one port and all functions of the general RTP and GRE are not required.

‘Amp’ is an interface for out-of-band signaling in a control procedure provided in a frame protocol, and forms a separate interface (hereafter referred to as an “Amp interface”). When an Amp interface interworks with the media gateway 140 via the MSC emulator 130, Session Control Transmission Protocol (SCTP) is used for a protocol stack.

A frame protocol defined in the protocol stack will be described in more detail herein below. A frame protocol operating on RTP and GRE provides a procedure for processing a voice data frame and a control procedure during transmission/reception of voice information between the media gateway 140 and the base station controller 121, and the frame protocol includes the following major functions.

First, the frame protocol has a function of making a frame before transmission of voice data information, receiving a frame, separating control information and voice data information from the corresponding frame, and analyzing the separated control information and voice data information.

Second, the frame protocol has an initialization fumction including a function of designating a frame number transmitted/received when a Quality-of-Service (QoS) of a transmission line or a frame is transmitted/received before voice data forwarding between the base station controller 121 and the media gateway 140.

Third, the frame protocol has a function of setting up and maintaining synchronization during actual transmission/reception through a report on a delay in order to resolve the delay occurring during real-time transmission/reception of voice data.

Fourth, the frame protocol has a vocoder transmission control function for equally changing a vocoder in the media gate way 140 during a change in data rate or transmission mode of a vocoder used by a mobile station.

Fifth, the frame protocol has a function of adjusting a rate of voice data transmitted from the media gateway 140 at a particular time in order to multiplex a signaling message and secondary traffic generated by the base station controller 121 using a Dim-and-Burst technique and a Blank-and-Burst technique and forwarding the multiplexed result to the mobile station.

Sixth, the frame control has a function of assigning a vocoder in the media gateway 140.

A method for assigning a vocoder using the sixth fumction among the functions of the frame protocol will be described herein below. In the following description, the vocoder resource assignment method is divided into a vocoder assignment procedure during call origination and a vocoder resource assignment procedure during hard handoff.

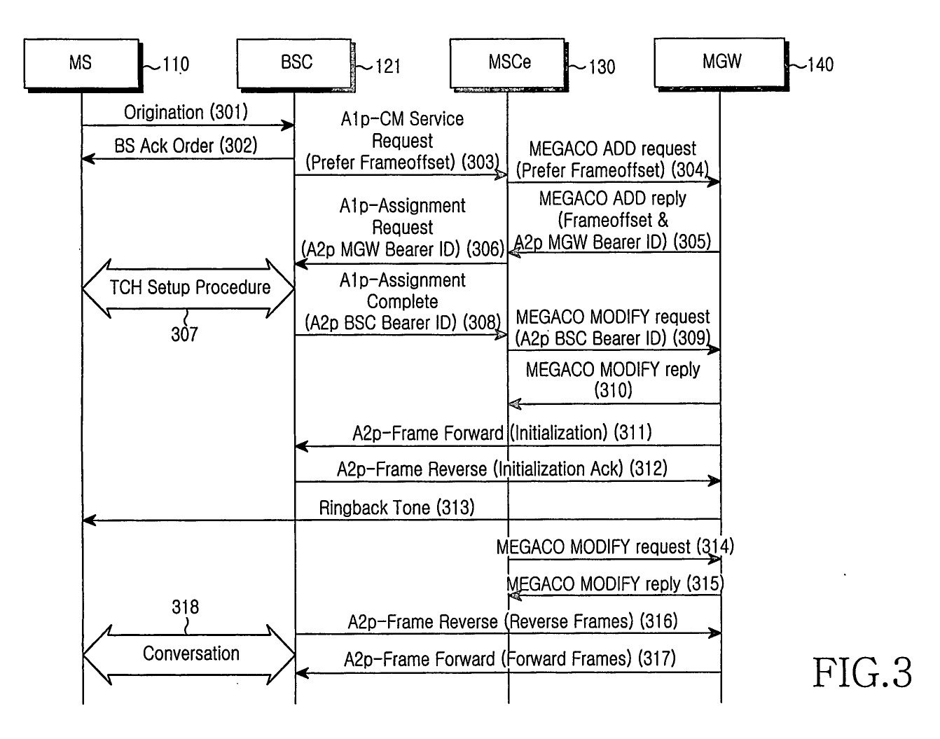

First, the vocoder assignment procedure during call origination will be described with reference to FIG. 3.

When a mobile station (MS) 110 needs an origination call for a voice signal, the mobile station 110 sends an Origination (or call attempt) message to a base station controller (BSC) 121 to request origination of a voice call in step 301. Although omitted in FIG. 3, an origination call of the mobile station 110 can be connected to the base station controller 121 via base transceiver stations 122a and 122b, or a router (not shown). In response, the bas station controller 121 sends a BS Ack Order message in step 302 to inform the mobile station 110 whether the Origination message has been received. Thereafter, in step 303, the base station controller 121 sends a Call Management (CM) Service Request message to an MSC emulator (MSCe) 130 using an A1p interface. Here, the base station controller 121 inserts Preferred Frame Offset for voice origination processing of the mobile station 110, received from the base transceiver stations 122a and 122b, and a bearer ID for voice data transmission into the CM Service Request message, before transmission. A value of Preferred Frame Offset means a frame offset value requested by the base station controller 121, and the bearer ID is used by a media gateway (MGW) 140 in setting up a bearer path for transmission of voice data. For example, RTP/IUDP/IP Port or GRE/IP port can be used as the bearer ID. Table 2 illustrates the CM Service Request message, particularly, illustrates how a frame offset and a bearer ID are inserted into a general CM Service Request message. Other fields except Frame Offset and Bearer ID are identical to corresponding fields in the general CM Service Request message.

TABLE 2

| | Element | | |
|---|---|---|---|
| Information Element | Direction | Type | |
| Protocol Discriminator | BS -> MSC | M^{m,v} | |
| Reserved - Octet | BS -> MSC | M^{v} | |
| Message Type | BS -> MSC | M^{v} | |
| CM Service Type | BS -> MSC | M^{m,v} | |
| Classmark Information Type 2 | BS -> MSC | M^{s,m,q,v} | |
| Mobile Identity (IMSI) | BS -> MSC | M^{m,v} | |
| Called Party BCD Number | BS -> MSC | O^{b} | C |
| Mobile Identity (ESN) | BS -> MSC | O^{m} | R |
| Slot Cycle Idenx | BS -> MSC | O^{c,r} | C |
| Authentication Response Parameter | BS -> MSC | O^{d} | C |
| (AUTHR) | | | |
| Authentication Confirmation Parameter | BS -> MSC | O^{e} | C |
| (RANDC) | | | |
| Authentication Parameter COUNT | BS -> MSC | O | C |
| Authentication Challenge Parameter | BS -> MSC | O^{f} | C |
| (RAND) | | | |
| Service Option | BS -> MSC | O^{g,m} | R |
| Voice Privacy Request | BS -> MSC | O | C |
| Radio Environment and Resources | BS -> MSC | O^{h} | R |
| Called Party ASCII Number | BS -> MSC | Oⁱ | C |
| Circuit Identity Code | BS -> MSC | O^{j} | C |
| Authentication Event | BS -> MSC | O^{k} | C |
| Authentication Data | BS -> MSC | O^{l} | C |
| PACA Reorigination Indicator | BS -> MSC | Oⁿ | C |
| User Zone ID | BS -> MSC | O | C |
| IS-2000 Mobile Capabilities | BS -> MSC | O^{o,t} | C |
| CLMA Serving One Way Delay | BS -> MSC | O^{p} | C |
| Special Service Call Indicator | BS -> MSC | O^{s} | C |
| Service Option Connection Identifier | BS -> MSC | O^{t} | C |
| (SOCI) | | | |
| Protocol Revision | BS -> MSC | O^{u} | C |
| Origination Continuation Indicator | BS -> MSC | O^{w} | C |
| Return Cause | BS -> MSC | O^{x} | C |
| Frame Offset | BS -> MSC | O | C |
| Bearer ID | BS -> MSC | O | C |

In step 304, the MSC emulator 130 receiving the CM Service Request message inserts the Preferred Frame Offset value received from the base station controller 121 into a Media Gateway Control (MEGACO) Add Request message in the form of Session Description Protocol (SDP) information before transmission, in order to send a vocoder resource setup request to the media gateway 140.

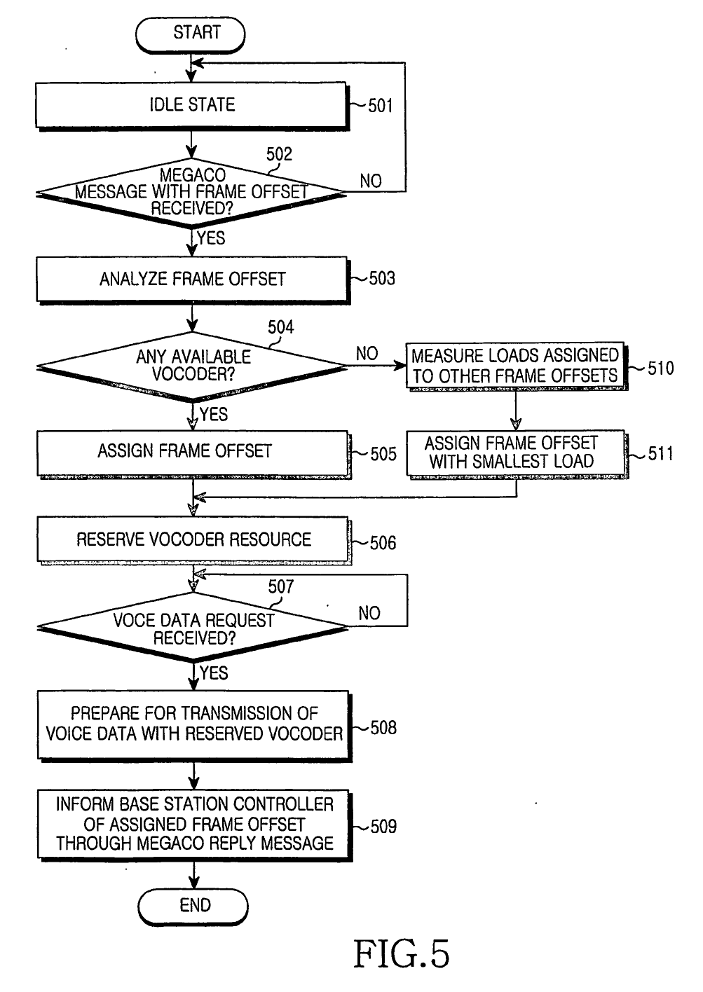

In step 305, the media gateway 140 receiving the MEGACO Add Request message from the MSC emulator 130 inserts Assigned Frame Offset information finally determined in a vocoder as a decision for a request of the Preferred Frame Offset requested by the base station controller 121 into a MEGACO Add Reply message in the form of SDP information, before transmission. At the same time, the media gateway 140 also designates MGW Bearer ID in the MEGACO Add Reply message before transmission. Thereafter, the media gateway 140 prepares necessary vocoder resource. A frame offset method for resource assignment in a vocoder will be described with reference to FIG. 5. In step 306, the MSC emulator 130 includes the MGW Bearer ID received from the media gateway 140 and the Assigned Prame Offset value determined in the media gateway 140 in an Assignment Request message for ordering radio channel setup, and transmits the Assignment Request message to the base station controller 121. Table 3 illustrates the Assignment Request message, particularly, illustrates how a frame offset and a bearer ID are inserted into a general Assignment Request message. Other fields except Frame Offset and Bearer ID are identical to corresponding fields in the general Assignment Request message.

TABLE 3

| | Element | | |
|---|---|---|---|
| Information Element | Direction | Type | |
| Message Type | MSC -> BS | M | |
| Channel Type | MSC -> BS | M^{a} | |
| Circuit Identity Code | MSC -> BS | O^{b} | C |
| Encryption Information | MSC -> BS | O^{c} | C |
| Service Option | MSC -> BS | O^{d} | R |
| Signal | MSC -> BS | O^{e,g} | C |
| Calling Party ASCII Number | MSC -> BS | O^{f,g} | C |
| MS Information Records | MSC -> BS | O^{h} | C |
| Priority | MSC -> BS | O^{k} | C |
| PACA Timestamp | MSC -> BS | O^{l} | C |
| Quality of service Parameters | MSC -> BS | O^{j} | C |
| Service Option Connection Identifier (SOCI) | MSC -> BS | O^{l} | C |
| Frame Offset | MSC -> BS | O | C |
| Bearer ID | MSC -> BS | O | C |

In step 307, a radio traffic channel is set up between the mobile station 110 and the base station controller 121 based on the Assignment Request message for ordering radio channel setup in step 306. In step 308, the base station controller 121, after the radio traffic channel is set up, sends an Assignment Complete message to the MSC emulator 130 to inform completion of the channel setup. At the same time, the base station controller 121 adds Bearer ID for voice data transmission. Table 4 illustrates the Assignment Complete message, particularly, illustrates how a bearer ID is inserted into a general Assignment Complete message. Other fields except Bearer ID are identical to corresponding fields in the general Assignment Complete message.

TABLE 4

| Information Element | Element Direction | Type | |
|---|---|---|---|
| Message Type | BS -> MSC | M | |
| Channel Number | BS -> MSC | M^{c} | |
| Encryption Information | BS -> MSC | O^{a} | C |
| Service Option | BS -> MSC | O^{b} | R |
| Service Option Connection Identifier (SOCI) | BS -> MSC | O^{d} | C |
| BearerlD | BS -> MSC | O | C |

In step 309, the MSC emulator 130 sends the media gateway 140 a MEGACO Modify Request message into which a bearer ID of the base station controller is inserted so that media gateway bearer setup is completed. In step 310, the media gateway 140 sends a MEGACO Modify Reply message to inform that bearer setup of the media gateway is completed. In step 311, the media gateway 140 sends the base station controller 121 an A2p-Frame Forward (Initialization) message which is an in-of-band signaling message using an A2p interface or an Amp Initialization message which is an out-of-band signaling message using an Amp interface in an initialization procedure, for voice data transmission between the media gateway 140 and the base station controller 121. At the same time, the media gateway 140 designates information on QoS necessary for a transmission line and a sequence number of a frame to be newly started in the corresponding message before transmission.

In step 312, the base station controller 121 performs initialization such as QoS setup according to the Initialization Procedure received through the A2p-Frame Forward message, and then sends the media gateway 140 an A2p-Frame Reverse message or an Amp Initialization Ack message as a response for the Initialization Ack. In step 313, the media gateway 140 sends a ring back tone to the mobile station 110. In step 314, the MSC emulator 130 sends a MEGACO Modify Request message to the media gateway 140 so that bearer setup of the media gateway is performed. In step 315, the media gateway 140 sends a MEGACO Modify Reply message to the MSC emulator 130 to inform that bearer setup of the media gateway is completed. Thereafter, in step 316, the base station controller 121 includes a voice data frame received from the mobile station 110 in an A2p-Frame Reverse message together with a voice data rate and information bits, and transmits the A2p-Frame Reverse message to the media gateway 140. In step 317, the media gateway 140 include the voice data frame received from the media gateway in an A2p-Frame Forward message together with a voice data rate and information bits, and transmits the A2p-Frame Forward message to the base station controller 121. Thereafter, in step 318, the mobile station 110 sets up a session to the base station controller 121 and then performs voice communication with the called party.

FIG. 3 has illustrated a vocoder resource assignment procedure applied when the mobile station 110 originates a call, and it is also applied when a voice call is received at the mobile station 110. In this case, an operation of inserting Preferred Frame Offset in a Page Response message, transmitting the Page Response message from the base station controller 121 to the MSC emulator 130, and sending the Page Response message from the MSC emulator 130 to the media gateway 140 through a MEGACO message is identical to the operation performed when the mobile station 110 originates a call. Because the case where the voice call is received is different only in application from and identical in actual operation to the case where the voice call is originated, a description of a call scenario will not be given. Table 5 illustrates the Page Response message, particularly, illustrates how a frame offset and a bearer ID is inserted into a general Page Response message. Other fields except Frame Offset and Bearer ID are identical to corresponding fields in the general Page Response message.

TABLE 5

| | Element | | |
|---|---|---|---|
| Information Element | Direction | Type | |
| Protocol Discriminator | BS -> MSC | M^{j,q} | |
| Reserved - Octet | BS -> MSC | M^{q} | |
| Message Type | BS -> MSC | M^{q} | |
| Classmark Information Type 2 | BS -> MSC | M^{a,j,i.q} | |
| Mobile Identity (IMSI) | BS -> MSC | M^{j} | |
| Tag | BS -> MSC | O | C |
| Mobile Identity (ESN) | BS -> MSC | O | R |
| Slot Cycle Index | BS -> MSC | O^{b,m} | C |
| Authentication Response Parameter (AUTHR) | BS -> MSC | O^{c} | C |
| Authentication Confirmation Parameter | BS -> MSC | O^{d} | C |
| (RANDC) | | | |
| Authentication Parameter COUNT | BS -> MSC | O | C |
| Authentication Challenge Parameter (RAND) | BS -> MSC | O^{e} | C |
| Service Option | BS -> MSC | O^{f,j} | R |
| Voice Privacy Request | BS -> MSC | O | C |
| Circuit Identity Code | BS -> MSC | O^{g} | C |
| Authentication Event | BS -> MSC | O^{h} | C |
| Radio Environment and Resources | BS -> MSC | Oⁱ | R |
| User Zone ID | BS -> MSC | O | C |
| IS-2000 Mobile Capabilities | BS -> MSC | O^{k,m} | C |
| CDMA Serving One Way Delay | BS -> MSC | O^{n,m} | C |
| Service Option Connection Identifier (SOCI) | BS -> MSC | O^{m,o} | C |
| Protocol Revision | BS -> MSC | O^{p} | C |
| Frame Offset | BS -> MSC | O | C |
| Bearer ID | BS -> MSC | O | C |

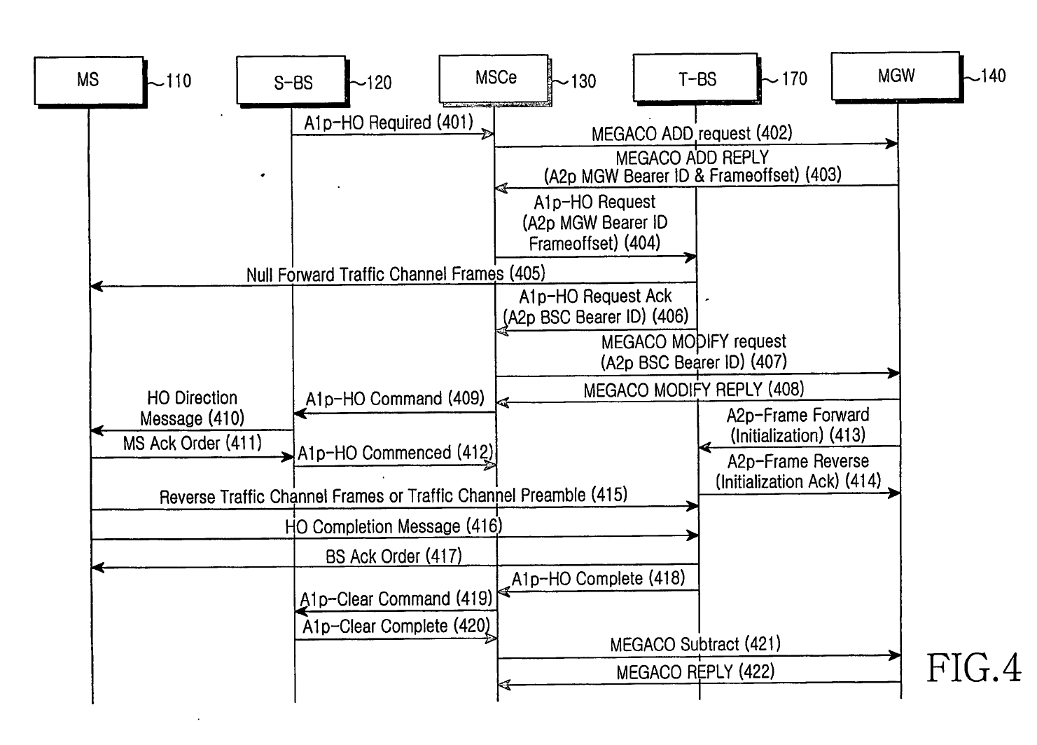

FIG. 4 is a scenario illustrating a vocoder resource assignment method during hard handoff in a mobile communication system according to another embodiment of the present invention. FIG. 3 illustrates an example of an out-of-band signaling message using an independent signaling message on Amp which is a separate signaling interface between the base station controller 121 and the media gateway 140.

It is assumed herein that if signal power reported by a mobile station 110 exceeds signal power defined in a network, a source base station (S-BS) 120 performs hard handoff to one or more cells under a target base station (T-BS) 170. In step 401, the source base station 120 sends a Handoff Required message to an MSC emulator 130 together with a list of corresponding cells. Table 6 illustrates the Handoff Required message, particularly, illustrates how a frame offset and a bearer ID is inserted into a general Handoff Required message. Other fields except Frame Offset and Bearer ID are identical to corresponding fields in the general Handoff Required message.

TABLE 6

| Information Element | Element Direction | Type | |
|---|---|---|---|
| Message Type | MSC -> BS | M | |
| Channel Type | MSC -> BS | M^{g} | |
| Encryption Information | MSC -> BS | M^{b} | |
| Classmark Information Type 2 | MSC -> BS | M^{c,o} | |
| Cell Identifier List (Target) | MSC -> BS | M^{d} | |
| Circuit Identity Code Extension | MSC -> BS | O^{e} | C |
| IS-95 Channel Identity | MSC -> BS | O^{f,p} | C |
| Mobile Identity (IMSI) | MSC -> BS | O^{g} | R |
| Mobile Identity (ESN) | MSC -> BS | O^{g} | R |
| Downlink Radio Environment | MSC -> BS | O^{h,q} | R |
| Service Option | MSC -> BS | O^{t} | C |
| CDMA Serving One Way Delay | MSC -> BS | O^{q} | R |
| MS Measured Channel Identity | MSC -> BS | O^{i,q} | C |
| IS-2000 Channel Identity | MSC -> BS | O^{i,q} | C |
| Quality of Service Parameters | MSC -> BS | O^{t} | C |
| IS-2000 Mobile Capabilities | MSC -> BS | O^{h} | C |
| C IS-2000 Service Configuration Record | MSC -> BS | O^{q,b} | C |
| Source PDSN Address | MSC -> BS | O^{l,a} | C |
| Protocol Type | MSC -> BS | O^{m,a} | C |
| Source RNC to Target RNC Transparent | MSC -> BS | O^{t} | C |
| Container | | | |
| Slot Cycle Index | MSC -> BS | O^{q,a} | C |
| Access Network Identifiers | MSC -> BS | O^{n,a} | C |
| Service Option List | MSC -> BS | O^{u} | C |
| IS-2000 Channel Identity 3X | MSC -> BS | O^{p,v} | C |
| Anchor PDSN Address | MSC -> BS | O^{w} | C |
| IS-2000 Non-negotiable Service | MSC -> BS | O^{x,q} | C |
| Configuration Record | | | |
| Anchor P-P Address | MSC -> BS | O^{x} | C |
| Protocol Revision | MSC -> BS | O^{z} | C |
| Packet Session Parameters | MSC -> BS | O^{a,a} | C |
| Frame Offset | MSC -> BS | O | C |
| Bearer ID | MSC -> BS | O | C |

In step 402, the MSC emulator 130 receiving the Handoff Required message sends a MEGACO Add Request message to a media gateway 140 in order to request vocoder resource and setup of a bearer path from the target base station 170 to the media gateway 140. In step 403, the media gateway 140 receiving the MEGACO Add Request message from the MSC emulator 130 designates MGW Bearer ID to setup a bearer to the target base station 170, and includes a value for a current frame offset to be used by the mobile station 110 in a MEGACO Add Reply message before transmission. A vocoder resource assignment method in the media gateway 140 will be described with reference to FIG. 5. In step 404, if a hard handoff bit included in the Handoff Required message received from the source base station 120 is designated to ‘1’ meaning hard handoff, the MSC emulator 130 sends the target base station 170 a Handoff Required message including current TIA/EIA-95 Channel Identity element and media gateway ID, and a frame offset value determined in the media gateway 140. If the Handoff Required message is received from the MSC emulator 130, the target base station 170 sends Null Forward Traffic Channel Frames to the corresponding mobile station 100 in step 405. In step 406, the target base station 170 inserts BSC Bearer ID into a Handoff Request Acknowledge message and sends the Handoff Request Acknowledge message to the MSC emulator 130. Table 7 illustrates the Handoff Request Acknowledge message, particularly, illustrates how a bearer ID is inserted into a general Handoff Request Acknowledge message. Other fields except Bearer ID are identical to corresponding fields in the general Handoff Request Acknowledge message.

TABLE 7

| Information Element | Element Direction | Type | |
|---|---|---|---|
| Message Type | BS -> MSC | M | |
| IS-95 Channel Identity | BS -> MSC | O^{a,f} | C |
| Cell Identifier List | BS -> MSC | O^{b} | R |
| Extended Handoff Direction Parameters | BS -> MSC | O^{f} | C |
| Hard Handoff Parameters | BS -> MSC | O^{f} | C |
| IS-2000 Channel Identity | BS -> MSC | O^{c,f} | C |
| IS-2000 Service Configuration Record | BS -> MSC | O^{d,f} | C |
| IS-2000 Non-Negotiable Service | BS -> MSC | O^{e,f} | C |
| Configuration Record | | | |
| Target RNC to Source RNC Transparent | BS -> MSC | O^{g} | C |
| Container | | | |
| Service Option List | BS -> MSC | O^{h} | C |
| Cause | BS -> MSC | Oⁱ | C |
| IS-2000 Channel Identity 3X | BS -> MSC | O^{f,j} | C |
| Protocol Revision | BS -> MSC | O^{k} | C |
| Bearer ID | BS -> MSC | O | C |

In step 407, the MSC emulator 130 sends the media gateway 140 a MEGACO Modify Request message into which BSC Bearer ID is inserted so that bearer setup of the media gateway 140 is completed. In step 408, the media gateway 140 sends a MEGACO Modify Reply message to inform completion of MGW bearer setup. In step 409, the MSC emulator 130 prepares for switching from the source base station 120 to a target base station controller 121b, and sends a Handoff Command message to the source base station 120. In step 410, the source base station 120 sends one of General Handoff Direction/Extended Handoff Direction/Universal Handoff Direction messages to the mobile station 110. In step 411, the mobile station 110 sends an MS Ack Order message to the source base station 120 in acknowledgement of the Handoff Direction message. In step 412, the source base station 120 sends a Handoff Command (or Handoff Start) message to the MSC emulator 130 in order to inform completed preparation for moving to a channel for the target base station controller 121b. In step 413, the media gateway 140 sends the target base station 170 an A2p-Frame Forward message which is an in-of-band signaling message or an Amp-Initialization message which is an out-of-band signaling message in an initialization procedure, for voice data transmission between the media gateways. At the same time, the media gateway 140 designates information on QoS necessary for a transmission line and a sequence number of a frame to be newly started before transmission. In step 414, the target base station 170 performs initiaization such as QoS setup according to the Initialization Procedure received through the A2p-Frame Forward message, and then sends the media gateway 140 an A2p-Frame Reverse message or an Amp-Initialization Ack message as an Initialization Ack message. In step 415, the base station 110 sends Reverse Traffic Channel Frames or a Traffic Channel Preamble to the target base station controller 121b in order to match reverse synchronization. In step 416, the mobile station sends a Handoff Complete message to the target base station 170. In step 417, the target base station 170 wirelessly sends a BS Ack Order message to the mobile station 110. In step 418, the target base station 170 sends the MSC emulator 130 a Handoff Complete message to inform successful completion of hard handoff on the mobile station 110. In step 419, the MSC emulator 130 sends Clear Command to the source base station 120. In step 420, the source base station 120 sends the MSC emulator 130 a Clear Complete message indicating successful completion of Clear. In step 421, the MSC emulator 130 sends the media gateway 140 a MEGACO Subtract Request message for clearing a bearer connected to the existing source base station 120. In step 422, the media gateway 140 sends a MEGACO Subtract Reply message to the MSC emulator 130.

FIG. 5 is a flowchart illustrating a frame offset assignment method during vocoder resource assignment in a media gateway.

In step 501, a media gateway 140 is in an idle state. The media gateway 140 determines in step 502 whether a MEGACO message including a frame offset preferred by a base station controller 121 has been received. Table 8 illustrates the MEGACO message, especially, illustrates how frame offset information to be added is inserted into a general MEGACO message. Here, the MEGACO message is generated not by existing binary coding, but by text coding. Therefore, information on a frame offset proposed in the present invention can be added when the MSC emulator 130 requests initial bearer setup to the media gateway 140, and can be inserted into Bearer Setup Information Element in the MEGACO message.

TABLE 8

| Address Information | Control Information | Bearer Information |
|---|---|---|
| | Frame Offset = Frame offset | |
| | number (Type 1) | |
| | Frame Offsets and their | |
| | Priorities = Frame Offsets and | |
| | their priorities (Type 2) | |

Here, the base station controller 121 can sort the frame offsets according to their loads, sort a total of 16 frame offsets according to their priorities, and transmit a frame offset corresponding to the smallest load to the MSC emulator 130. If it is determined that a MEGACO message including a frame offset preferred by the base station controller 121 has not been received, the media gateway 140 returns to step 501 where it maintains the idle state. However, if a MEGACO message including a frame offset preferred by the base station controller 121 has been received, the media gateway 140 proceeds to step 503 where it analyzes, for each frame offset, an entire load of a base transceiver station (BTS) managed by the media gateway 140 through the MEGACO message including the frame offset preferred by the base station controller 121 in step 503. As a result of the analysis, the media gateway 140 determines in step 504 whether there is any vocoder resource supporting a frame offset preferred by the base station controller 121. If there is any available vocoder resource supporting a frame offset preferred by the base station controller 121, the media gateway 140 assigns a frame offset provided from the base station controller 121 in step 505, and reserves vocoder resource corresponding thereto in step 506. In step 507, the media gateway 140 determines whether a voice request has been received through a voice transmission bearer path of the mobile station 110. If a voice request has been received through a voice transmission bearer path of the mobile station 110, the media gateway 140 prepares for transmission of voice data with the reserved vocoder in step 508. Thereafter, in step 509, the media gateway 140 informs the base station controller 121 of the assigned frame offset via the MSC emulator 130 through a MEGACO Reply message.

However, if it is determined in step 504 that there is no available vocoder resource supporting a frame offset preferred by the base station controller 121, the media gateway 140 measures a load assigned to other frame offsets in step 510, and assigns a frame offset with the smallest load among the frame offsets in step 511. In step 506, the media gateway 140 reserves vocoder resource corresponding thereto. In step 507, the media gateway 140 determines whether a voice has been received through a voice transmission bearer path of the mobile station 110. If a voice has been received through a voice transmission bearer path of the mobile station 110, the media gateway 140 prepares for transmission of voice data with the reserved vocoder in step 508. Thereafter, in step 509, the media gateway 140 informs the base station controller 121 of the frame offset via the MSC emulator 130 through a MEGACO Reply message.

As described above, a mobile communication system efficiently assigns vocoder resource in a media gateway by uniformly distributing vocoder voice data between the media gateway with a transcoder (or vocoder) and a base station controller to all vocoder resources instead of concentrating the vocoder voice data to a certain vocoder resource.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for assigning resource in a media gateway in a mobile communication system, the method comprising the steps of:
receiving a control message having a frame offset included therein;
determining whether there is any resource supporting the frame offset included in the control message; and
assigning the resource if there is any resource supporting the frame offset.

2. The method of claim 1, further comprising the steps of:
measuring loads assigned to other frame offsets if there is no available resource corresponding to the frame offset value; and
assigning a frame offset with a smallest load among the measured loads.

3. The method of claim 1 or 2, further comprising the step of, if a voice data request has been received from a mobile station, transmitting data with resource having the assigned frame offset and sending a reply control message including the assigned frame offset to a base station controller.

4. The method of claim 1, further comprising the step of analyzing an entire load of a base station for each frame offset if the control message with the frame offset has been received.

5. The method of claim 1, wherein the resource is vocoder resource.

6. The method of claim 1, wherein the media gateway includes a plurality of vocoders.

7. A method for transmitting/receiving packet data using a base station in a mobile communication system for transmitting/receiving the packet data including a voice call, the method comprising the steps of:
receiving a call attempt message from a mobile station;
transmitting a service request message including a frame offset for call processing;
receiving a frame offset included in a reply message for the service request message; and
setting up a radio channel to the mobile station based on the received frame offset.

8. The method of claim 7, wherein a frame offset included in the reply message for the service request message is identical to a frame offset included in the service request message for call processing.

9. The method of claim 8, wherein a frame offset included in the reply message for the service request message is a frame offset newly assigned by a media gateway.

10. The method of claim 8, further comprising the steps of:
transmitting a service request message including a bearer ID for the call processing; and
receiving a bearer ID included in the reply message for the service request message.

11. An apparatus for assigning resource in a mobile communication system including a mobile switching center (MSC) emulator (MSCe) for performing a switching operation of a voice call, a media gateway (MGW) connected to the MSC emulator, and a base station (BS) connected to the MSC emulator and the media gateway, for communicating with a mobile station using a radio channel, the apparatus comprising:
the base station for, upon receiving a voice call request from the mobile station, transmitting a Call Management (CM) service request message including a frame offset value to the MSC emulator, and setting up a radio channel to the mobile station by receiving information including a frame offset determined in the media gateway;
the MSC emulator for sending the CM service request message received from the base station to the media gateway, and sending the information including the frame offset received from the media gateway to the base station; and
the media gateway for receiving the CM service request message from the MSC emulator, assigning resource by determining a frame offset, sending the determined frame offset to the MSC emulator, and performing communication using resource assigned according to the determined frame offset when the mobile station originates a call.

12. The apparatus of claim 11, wherein the CM service request message further includes a bearer ID.

13. The apparatus of claim 12, wherein the media gateway has a plurality of vocoders.

14. The apparatus of clam 12, wherein the resource is vocoder resource.

15. A method for assigning resource in a mobile communication system including a mobile switching center (MSC) emulator (MSCe) for performing a switching operation of a voice call, a media gateway (MGW) connected to the MSC emulator, and a base station (BS) connected to the MSC emulator and the media gateway, for communicating with a mobile station using a radio channel, the method comprising the steps of:
sending, by a source base station, a handoff request signal including a frame offset to the MSC emulator when a mobile station performing a voice call with the media gateway packet by packet needs handoff;
transmitting by the MSC emulator a Media Gateway Control (MEGACO) add request message including the frame offset to the media gateway;
assigning by the media gateway a frame offset of a base station based on a received MEGACO add request message, and sending a reply message according thereto to the MSC emulator;
sending by the MSC emulator the frame offset included in the reply message to a handoff target base station using a handoff request signal; and
performing, by the media gateway, communication using resource assigned based on the determined frame offset during handoff of the mobile station.

16. The method of claim 15, further comprising the steps of:
assigning by the target base station a forward traffic channel to a mobile station to be handed off in response to the handoff request signal, generating a reply signal therefor, and sending the reply signal to the MSC emulator;
sending by the MSC emulator a handoff command message to a source base station that requested the handoff;
performing, by the source base station that requested the handoff, handoff with the mobile station, and sending a handoff start message to the MSC emulator;
sending by the MSC emulator a request for modifying voice call processing with the target base station to the media gateway; and
modifying, by the media gateway, information on voice call processing with the target base station.

17. The method of claim 15, further comprising the steps of:
measuring loads assigned to other frame offsets if there is no available vocoder resource corresponding to the frame offset value;
assigning a frame offset with a smallest load among the measured loads;
reserving vocoder resource corresponding to the frame offset value;
preparing for transmission of voice data with the reserved vocoder when voce data is transmitted through a voice transmission bearer path of the mobile station; and
informing a base station controller of the assigned frame offset through a control reply message.

18. The method of claim 15, wherein a bearer path for the bearer setup uses an RTP/UDP/IP port or a GRE/IP port.

19. The method of claim 15, wherein the media gateway has a plurality of vocoders.
